(19) United States
(12) Patent Application Publication
(10) Pub. No.: US 2025/0203421 A1
(43) Pub. Date: Jun. 19, 2025

(54) INFORMATION PROCESSING METHOD AND APPARATUS AND COMMUNICATION DEVICE

(71) Applicant: VIVO MOBILE COMMUNICATION CO., LTD., Guangdong (CN)

(72) Inventors: Jian YAO, Guangdong (CN); Dajie JIANG, Guangdong (CN); Yannan YUAN, Guangdong (CN)

(73) Assignee: VIVO MOBILE COMMUNICATION CO., LTD., Guangdong (CN)

(21) Appl. No.: 19/070,865

(22) Filed: Mar. 5, 2025

Related U.S. Application Data
(63) Continuation of application No. PCT/CN2023/115665, filed on Aug. 30, 2023.

(30) Foreign Application Priority Data
Sep. 5, 2022 (CN) 202211079534.9

(51) Int. Cl. H04W 24/08; H04W 64/00

(52) U.S. Cl. CPC H04W 24/08; H04W 64/00

(57) ABSTRACT

An information processing method and apparatus and a communication device. The information processing method in embodiments of this application includes: A first device acquires first information of a second device, where the first information includes a sensor measurement result of the second device. The first device executes a first operation according to the sensor measurement result, where the first operation is related to at least one of a communication service and a sensing service. The sensor measurement result includes at least one of the following: a motion-related information measurement result, a position-related information measurement result, and an environment-related information measurement result.

### CROSS-REFERENCE TO RELATED APPLICATIONS

This application is a continuation of International Application No. PCT/CN2023/115665 filed on Aug. 30, 2023, which claims priority to Chinese Patent Application No. 202211079534.9 filed on Sep. 5, 2022, which are incorporated herein by reference in their entireties.

### TECHNICAL FIELD

This application belongs to the technical field of communication, and in particular, to an information processing method and apparatus and a communication device.

### BACKGROUND

A sensing capability is a capability of one or more devices to sense information such as an orientation, a distance, or a velocity of a target object or to detect, track, recognize, or image a target object, an event, an environment, or the like by transmitting and receiving wireless signals. In the related art, when a network or a terminal performs communication or sensing based on measurement of a wireless signal, other factors (such as a moving velocity of a device and an environmental factor) affect a communication performance or a sensing performance, thereby degrading the communication performance or the sensing performance.

### SUMMARY

Embodiments of this application provide an information processing method and apparatus and a communication device.

In a first aspect, an information processing method is provided, including:

A first device acquires first information of a second device, where the first information includes a sensor measurement result of the second device.

The first device executes a first operation according to the sensor measurement result, where the first operation is related to at least one of a communication service and a sensing service.

The sensor measurement result includes at least one of the following:
a motion-related information measurement result;
a position-related information measurement result; or
an environment-related information measurement result.

In a second aspect, an information processing method is provided, including:

A second device transmits first information to a first device, where the first information includes a sensor measurement result of the second device, and the sensor measurement result is related to at least one of a communication service and a sensing service.

The sensor measurement result includes at least one of the following:
a motion-related information measurement result;
a position-related information measurement result; or
an environment-related information measurement result.

In a third aspect, an information processing apparatus is provided. The apparatus is applied to a first device and includes:
a first acquisition module, configured to acquire first information of a second device, where the first information includes a sensor measurement result of the second device; and
a first processing module, configured to execute a first operation according to the sensor measurement result, where the first operation is related to at least one of a communication service and a sensing service.

The sensor measurement result includes at least one of the following:
a motion-related information measurement result;
a position-related information measurement result; or
an environment-related information measurement result.

In a fourth aspect, an information processing apparatus is provided. The apparatus is applied to a second device and includes:
a first transmitting module, configured to transmit first information to a first device, where the first information includes a sensor measurement result of the second device, and the sensor measurement result is related to at least one of a communication service and a sensing service.

The sensor measurement result includes at least one of the following:
a motion-related information measurement result;
a position-related information measurement result; or
an environment-related information measurement result.

In a fifth aspect, a terminal (second device) is provided. The terminal includes a processor and a memory. The memory stores a program or an instruction executable on the processor. The program or the instruction, when executed by the processor, implements the steps of the method in the second aspect.

In a sixth aspect, a terminal (second device) is provided, including a processor and a communication interface. The communication interface is configured to transmit first information to a first device, where the first information includes a sensor measurement result of the second device, and the sensor measurement result is related to at least one of a communication service and a sensing service.

The sensor measurement result includes at least one of the following:
a motion-related information measurement result;
a position-related information measurement result; or
an environment-related information measurement result.

In a seventh aspect, a network-side device (first device) is provided. The network-side device includes a processor and a memory. The memory stores a program or an instruction executable on the processor. The program or the instruction, when executed by the processor, implements the steps of the method in the first aspect.

In an eighth aspect, a network-side device (first device) is provided, including a processor and a communication interface. The communication interface is configured to acquire first information of a second device, where the first information includes a sensor measurement result of the second device. The processor is configured to execute a first operation according to the sensor measurement result, where the first operation is related to at least one of a communication service and a sensing service.

The sensor measurement result includes at least one of the following:
a motion-related information measurement result;
a position-related information measurement result; or
an environment-related information measurement result.

In a ninth aspect, an information processing system is provided, including: a terminal (second device) and a network-side device (first device), where the terminal may be configured to perform the steps of the method in the second aspect, and the network-side device may be configured to perform the steps of the method in the first aspect.

In a tenth aspect, a readable storage medium is provided. The readable storage medium has a program or an instruction stored therein. The program or the instruction, when executed by a processor, implements the steps of the method in the first aspect, or implements the steps of the method in the second aspect.

In an eleventh aspect, a chip is provided. The chip includes a processor and a communication interface. The communication interface is coupled to the processor. The processor is configured to execute a program or an instruction, to implement the method in the first aspect or implement the method in the second aspect.

In a twelfth aspect, a computer program/program product is provided. The computer program/program product is stored in a storage medium. The computer program/program product is executed by at least one processor to implement the steps of the method in the first aspect.

In the embodiments of this application, a first device acquires first information of a second device, where the first information includes a sensor measurement result of the second device.

### BRIEF DESCRIPTION OF THE DRAWINGS

FIG. 1 shows a structural diagram of a communication system to which an embodiment of this application is applicable;

FIG. 2 shows a schematic flowchart 1 of an information processing method according to an embodiment of this application;

FIG. 3 shows a schematic flowchart 2 of an information processing method according to an embodiment of this application;

FIG. 4 shows a schematic interaction diagram 1 of an information processing method according to an embodiment of this application;

FIG. 5 shows a schematic interaction diagram 2 of an information processing method according to an embodiment of this application;

FIG. 6 shows a schematic interaction diagram 3 of an information processing method according to an embodiment of this application;

FIG. 7 shows a schematic module diagram 1 of an information processing apparatus according to an embodiment of this application;

FIG. 8 shows a schematic module diagram 2 of an information processing apparatus according to an embodiment of this application;

FIG. 9 shows a structural block diagram of a communication device according to an embodiment of this application;

FIG. 10 shows a structural block diagram of a terminal according to an embodiment of this application;

FIG. 11 shows a structural block diagram 1 of a network-side device according to an embodiment of this application; and

FIG. 12 shows a structural block diagram 2 of a network-side device according to an embodiment of this application.

### DETAILED DESCRIPTION

Technical solutions in embodiments of this application are clearly and completely described in the following with reference to the accompanying drawings in the embodiments of this application. Apparently, the described embodiments are merely some rather than all the embodiments of this application. Based on the embodiments of this application, all other embodiments derived by those of ordinary skill in the art should fall within the protection scope of this application.

In the specification and claims of this application, terms such as “first” and “second” are used for distinguishing between similar objects instead of describing a particular order or sequence. It should be understood that terms used in this way may be interchanged under appropriate circumstances, such that the embodiments of this application can be implemented in an order other than those illustrated or described herein. In addition, the objects distinguished by “first” or “second” are usually objects of one class with the number of objects unlimited. For example, there may be one or more first objects. Furthermore, “and/or” in the specification and the claims represents at least one of connected objects, and character “/” generally represents an “or” relationship between associated objects before and after.

It is worth pointing out that the technology described in the embodiments of this application is not limited to a long term evolution (LTE)/LTE-advanced (LTE-A) system, and may alternatively be used in other radio communication systems, such as code division multiple access (CDMA), time division multiple access (TDMA), frequency division multiple access (FDMA), orthogonal frequency division multiple access (OFDMA), single-carrier frequency division multiple access (SC-FDMA), and other systems. The terms “system” and “network” in the embodiments of this application are often used interchangeably, and the described technology may be applied to the systems and radio technologies mentioned above, and may alternatively be applied to other systems and radio technologies. The following description describes a New Radio (NR) system for illustration, and NR terminology is used in most of the following descriptions. However, these technologies may alternatively be applied to applications other than NR system applications, such as 6th generation (6G) communication systems.

FIG. 1 shows a block diagram of a wireless communication system to which an embodiment of this application is applicable. The wireless communication system includes a terminal 11 and a network-side device 12. The terminal 11 may be a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home appliance (home equipment with a wireless communication function, such as a refrigerator, a TV, a washing machine, or furniture), and a terminal-side device such as a game console, a personal computer (PC), an ATM, or a self-service machine. The wearable device includes: a smartwatch, a smart band, a smart headset, smart glasses, smart jewelry (a smart bracelet, a smart chain bracelet, a smart ring, a smart necklace, a smart anklet, a smart ankle chain, or the like), a smart wrist strap, a smart garment, or the like. It should be noted that a specific type of the terminal 11 is not limited in this embodiment of this application. The network-side device 12 may include an access network device or a core network device. The access network device may alternatively be referred to as a radio access network device, a radio access network (RAN), a radio access network function, or a radio access network element. The access network device may include a base station, a wireless local area network (WLAN) access point, a WIFI node, or the like. The base station may be referred to as a Node B, an evolved Node B (eNB), an access point, a base transceiver station (BTS), a radio base station, a radio transceiver, a basic service set (BSS), an extended service set (ESS), a home Node B, a home evolved Node B, a transmission reception point (TRP), or some other suitable terms in the field. As long as the same technical effect is achieved, the base station is not limited to a particular technical word. It should be noted that in this embodiment of this application, only a base station in an NR system is described as an example, and a specific type of the base station is not limited. The core network device may include, but is not limited to, at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), a unified data management (UDM), a Unified Data Repository (UDR), a home subscriber server (HSS), a centralized network configuration (CNC), a network repository function (NRF), a network exposure function (NEF), a local NEF (L-NEF), a binding support function (BSF), an Application Function (AF), or the like. It should be noted that in this embodiment of this application, only a core network device in the NR system is described as an example, and a specific type of the core network device is not limited.

To make a person skilled in the art better understand this embodiment of this application, the following description is first carried out.

In addition to a communication capability, a future mobile communication system such as a B5G system or a 6G system is to further have a sensing capability. The sensing capability is a capability of one or more devices to sense information such as an orientation, a distance, or a velocity of a target object or to detect, track, recognize, or image a target object, an event, an environment, or the like by transmitting and receiving a wireless signal. In the future, with deployment of small base stations with high-frequency band and large bandwidth capabilities such as millimeter waves and terahertz in 6G networks, a sensing resolution will be significantly improved compared with centimeter waves, enabling the 6G networks to provide a more refined sensing service. Typical sensing functions and application scenarios are as shown in Table 1.

TABLE 1

| Communication and | | |
|---|---|---|
| sensing category | Sensing function | Application scenario |
| Macroscopic | Weather conditions, air quality, and | Meteorology, agriculture, and |
| sensing | the like | living services |
| category | Traffic flow (intersection) and | Intelligent transportation and |
| | pedestrian flow (subway entrance) | commercial services |
| | Target tracking, ranging, velocity | Many application scenarios of |
| | measurement, external contour, and | traditional radar |
| | the like | |
| | Environmental reconstruction | Intelligent driving and navigation |
| | | (cars/drones), smart cities (3 D |
| | | maps), and network planning and |
| | | optimization |
| Refined sensing | Action/posture/expression | Intelligent interaction, gaming, |
| | recognition | and smart home through smart |
| | | phones |
| | Heartbeat/respiration and the like | Health and medical care |
| | Imaging, material detection, | Security check, industry, |
| | composition analysis, and the like | biomedicine, and the like |

Integrated sensing and communication refers to the design of integrated communication and sensing functions through spectrum sharing and hardware sharing in the same system. The system can sense information such as orientation, distance, and velocity while transmitting information, and detect, track, and identify target objects or events. The communication system and the sensing system complement each other, achieving overall performance improvement and bringing better service experience.

Integration of communications and radar belongs to a typical communication sensing and integration application. In the past, a radar system and a communication system were strictly distinguished due to different research objects and focus on different systems. In most scenarios, the two systems are distributed and researched. In fact, the radar and communication systems are also used as typical manners of transmitting, acquiring, processing, and exchanging information, and there are many similarities in working principles, system architectures, or bands. The integrated design of communications and radar has great feasibility, and is mainly reflected in the following several aspects: First, a communication system and a sensing system both acquire and transfer information based on an electromagnetic wave theory by transmitting and receiving an electromagnetic wave. Second, the communication system and the sensing system both have structures such as an antenna, a transmitting end, a receiving end, and a signal processor, and have a great overlap in hardware resources. With the development of technologies, there is an increasing overlap between two working bands. In addition, there is a similarity in key technologies such as signal modulation, receiving and detection, and waveform design. The integration of the communication system and the radar system can bring many advantages, for example, cost reduction, size reduction, power consumption reduction, spectrum efficiency improvement, and mutual interference reduction, thereby improving overall system performance.

According to different sensing signal transmitting nodes and receiving nodes, there are the following six sensing links. It should be noted that, for each sensing link described below, a transmitting node and a receiving node are used as an example. In an actual system, different sensing links may be selected according to different sensing requirements, each sensing link may have one or more transmitting nodes and receiving nodes, and an actual sensing system may include multiple different sensing links.

1) Base station echo sensing: In this sensing mode, a base station transmits a sensing signal and obtains a sensing result by receiving echo of the sensing signal.

2) Inter-base station air interface sensing: At this moment, base station 2 receives a sensing signal transmitted by base station 1 and obtains a sensing result.

3) Uplink air interface sensing: At this moment, a base station receives a sensing signal transmitted by UE and obtains a sensing result.

4) Downlink air interface sensing: At this moment, UE receives a sensing signal transmitted by a base station and obtains a sensing result.

5) Terminal echo sensing: At this moment, UE transmits a sensing signal and obtains a sensing result by receiving echo of the sensing signal.

6) Inter-terminal sidelink sensing: For example, UE 2 receives a sensing signal transmitted by UE 1 and obtains a sensing result.

Channel information acquired by sensing a surrounding environment may be used in a communication system, to improve performance of the communication system, including terminal location, blocking prediction, non-line-of-sight detection, channel estimation, and other aspects. For a millimeter wave communication system, in a case that a codebook set is very large, a beam training process is very time-consuming. A terminal position is acquired by using a sensing technology, which can reduce overheads of beam training, and implement fast beam forming and tracking in a moving scenario. Further, a communication target is located and tracked, and a potential obstacle in a channel environment is predicted, so that beam switching can avoid a communication link failure caused by blockage. In addition, sensing of different objects in a surrounding environment helps to distinguish between a line-of-sight channel and a non-line-of-sight channel, to resolve a problem of high error rate of recognition when analysis is performed based on channel characteristics, and channel parameters acquired by sensing may also be used for improving the accuracy of communication channel estimation.

The following describes in detail the information processing method provided in this embodiment of this application through some embodiments and application scenarios thereof with reference to the accompanying drawings.

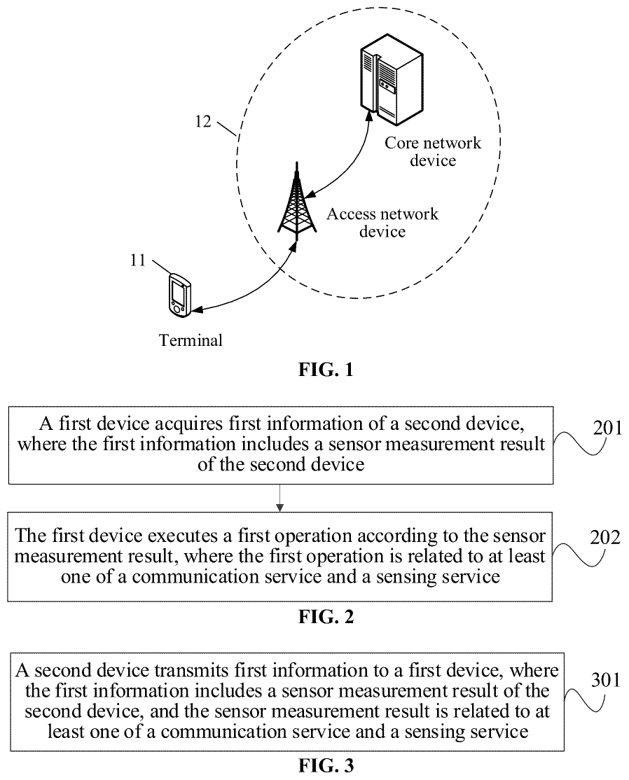

As shown in FIG. 2, an embodiment of this application provides an information processing method, including the following steps.

Step 201: A first device acquires first information of a second device, where the first information includes a sensor measurement result of the second device.

The first device is a base station, a sensing network function, or a sensing network element (Sensing Management Function, Sensing MF). The second device may be specifically a terminal.

Functional characteristics of the sensing network function/sensing network element include at least one of the following:
a. Target information interaction with a target sensing signal transmitting device and/or a sensing signal measurement device (including a target UE or a serving base station of the target UE or a base station associated with a target area) is performed, where the target information includes a sensing processing request, a sensing capability, sensing auxiliary data, a sensing measurement quantity type, sensing resource configuration information, and the like, to obtain a value of a target sensing result or a sensing measurement quantity (uplink measurement quantity or downlink measurement quantity) transmitted by the sensing signal measurement device.
b. A to-be-used sensing method is determined according to factors such as a type of a sensing service, sensing service consumer information, required sensing quality of service (QOS) requirement information, a sensing capability of a sensing signal transmitting device, and a sensing capability of a sensing signal measurement device, where the sensing method includes: transmitting the information by base station A and receiving the information by base station B, or transmitting the information by a base station and receiving the information by UE, or transmitting and receiving the information by base station A, or transmitting the information by UE and receiving the information by a base station, or transmitting and receiving the information by UE, or transmitting the information by UE A and receiving the information by UE B, or the like.
c. A sensing device serving a sensing service is determined based on factors such as a type of the sensing service, sensing service consumer information, required sensing QoS requirement information, a sensing capability of a sensing signal transmitting device, and a sensing capability of a sensing signal measurement device, where the sensing device includes the sensing signal transmitting device and/or the sensing signal measurement device.
d. The overall coordination and scheduling of resources required by a sensing service are managed. For example, sensing resources of a base station and/or a UE are correspondingly configured.
e. Data is processed for a value of a sensing measurement quantity, or the value is calculated to obtain a sensing result. Further, a sensing result is verified, sensing accuracy is estimated, and the like.

The network sensing function/sensing network element may be located in a core network domain, an access network domain, a network management domain, or the like. The sensing network function/sensing network element may be a new network element having the foregoing functional characteristics, or a network element combined with an existing network function/network element (such as a location management function (LMF)).

Optionally, the second device is configured with at least one of the following sensors:

Accelerometer: An acceleration applied to the device is measured in a format of a=[aₓ, a_{y}, a_{z}]^{T}, including accelerations along an x-axis, a y-axis, and a z-axis. Further, there may further be a result including a gravitational acceleration, a result not including a gravitational acceleration, a result including deviation compensation, and a result not including deviation compensation.

Gyroscope: Rotation rates (radian/second) around the x, y, and z-axes of the device are measured, and may be represented as a three-dimensional vector similar to the accelerometer, ω=[ωₓ, ω_{y}, ω_{z}]^{T}.

Magnetometer: The change of the earth's magnetic field is monitored, and geomagnetic field strength data (in microtesla) along each of the three coordinate axes is measured, where the format is m=[mₓ, m_{y}, m_{z}]^{T}. Generally, the sensor does not need to be directly used, but is combined with another sensor to acquire rotation angle information.

Rotation vector sensor: A rotation vector sensor may be obtained by combining different sensors, to acquire a terminal angle, where the format is θ=[θₓ, θ_{y}, θ_{z}]^{T} (respectively corresponding to rotation angles of the terminal about the x, y, and z-axes, or rotation angles relative to an East-North-Up/North-East-Down).

Global navigation satellite system (GNSS): The terminal receives a satellite signal broadcast by a navigation satellite, demodulates and collects sufficient data information, and then resolves position information of a current receiving end.

Pressure sensor: An environmental air pressure value is acquired.

Optical sensor: Many mobile terminals are provided with an optical sensor to sense illumination brightness of a current environment of a user, and adjust screen brightness based on the illumination brightness.

Temperature sensor: An environmental temperature is acquired.

Humidity sensor: Relative humidity information of an environment may be acquired, or dew point and/or absolute humidity information may be acquired in combination with the temperature sensor.

The sensor measurement result includes at least one of the following:
a motion-related information measurement result;
a position-related information measurement result; or
an environment-related information measurement result.

Optionally, the first information further includes: image information or video information, and some types of abstract information obtained according to various sensor measurement results, for example, line of sight (LOS)/not line of sight (NLOS), obstacle/block information (for example, a network may pre-configure a particular direction, position, and depth, and the terminal is required to report a corresponding block for the particular direction, position, and depth), and environment information (the network pre-configures a typical scenario environment indoors/outdoors, or on a vehicle such as a high-speed railway, and the terminal is required to determine and report).

Step 202: The first device executes a first operation according to the sensor measurement result, where the first operation is related to at least one of a communication service and a sensing service.

In this embodiment of this application, a first device acquires first information of a second device, where the first information includes a sensor measurement result of the second device.

The sensor measurement result includes at least one of the following: a motion-related information measurement result; a position-related information measurement result; or an environment-related information measurement result. The first device executes a first operation according to the sensor measurement result. The first operation is related to at least one of a communication service and a sensing service, to achieve an objective of assisting in the communication service and/or the sensing service through sensor data. The impact of a motion of the device, a position of the device, an environment, or the like on a communication or sensing performance can be reduced through the sensor data, thereby facilitating improving the communication or sensing performance.

Optionally, the motion-related information measurement result includes at least one of the following:

First: Acceleration information of the second device.

Specifically, the information may be an acceleration along an x-axis, a y-axis, and/or a z-axis. The x/y/z axes may be coordinates of a local coordinate system (such as a sensor coordinate system), or may be coordinates of a global coordinate system (similarly hereinafter).

Further, the information may alternatively be original acceleration information including a gravity effect, or may be linear acceleration information not including a gravity effect.

Further, the information may be acceleration information without deviation compensation, or may be acceleration information with deviation compensation.

Second: Velocity information of the second device.

Specifically, the information may be a velocity along the x-axis, the y-axis, and/or the z-axis.

Third: Rotation rate information of the second device.

Specifically, the information may be a rotation rate around the x-axis, the y-axis, and/or the z-axis.

Further, the information may be rotation rate information without drift compensation, or may be rotation rate information with drift compensation.

Fourth: Rotation angle information of the second device.

Specifically, the information may be a rotation angle along the x-axis, the y-axis, and/or the z-axis.

Optionally, the position-related information measurement result includes at least one of the following:

First: Geomagnetic strength information.

Specifically, the information may be geomagnetic strength information along the x-axis, the y-axis, and/or the z-axis.

Second: Moving distance information of the second device.

Specifically, the information may be a moving distance along the x-axis, the y-axis, and/or the z-axis.

Third: Orientation information of the second device.

Specifically, the information may be sensor orientation information and/or antenna orientation information.

Fourth: Position information of the second device.

Specifically, the information may be current position information, or may be position information, deduced according to a velocity, at a future moment.

Fifth: Distance information between the second device and a target object.

For example, the distance information may be an absolute distance in centimeters, or may be a binary value representing a near or far state.

Optionally, the environment-related information measurement result includes at least one of the following:
an air temperature;
an illumination strength;
an air pressure; or
an air humidity.

Optionally, the first information further includes at least one of the following:
first indication information, where the first indication information is used for indicating a type of the sensor measurement result, the type of the sensor measurement result may be an acceleration, a velocity, a rotation rate, geomagnetic strength, a moving distance, a rotation angle, orientation information, position information, distance information between the second device and an object, environment information, or the like, and if the type of the sensor measurement result includes: an acceleration, a velocity, a moving distance, and an orientation, 2 bit may be used for indicating a data type;
second indication information, where the second indication information is used for indicating a type of a sensor corresponding to the sensor measurement result, and the second indication information is used for indicating a particular type of a sensor, for example, an accelerometer or a gyroscope, from which the sensor measurement result comes;
first time information, where the first time information is used for indicating time information at which the second device obtains the sensor measurement result; or
coordinate system relationship information, where the coordinate system relationship information is used for indicating relationship information between a coordinate system corresponding to the sensor measurement result and a first coordinate system, the first coordinate system may be a global coordinate system, and the coordinate system relationship information is, for example, a conversion parameter from a coordinate system corresponding to the sensor measurement result to the global coordinate system, i.e. a rotation angle of a local coordinate system relative to the global coordinate system: α (bearing angle), β (downward inclination angle), and γ (inclination angle). Optionally, an origin of the local coordinate system may be a position of a UE antenna panel, and the global coordinate system may be a base station.

Optionally, in this embodiment of this application, before the first device acquires first information, the method further includes:
transmitting third indication information to the second device, where the third indication information is used for instructing the second device to transmit the first information.

Optionally, the third indication information includes at least one of the following:
transmitting indication information, where the transmitting indication information is used for indicating whether the second device transmits the sensor measurement result, the transmitting indication information may, for example, be represented by 1 bit, when a value of 1 bit is 1, it indicates that the second device transmits the sensor measurement result, and when the value of 1 bit is 0, it indicates that the second device does not transmit the sensor measurement result;
a type of a sensor expected to be used by the first device;
a type of sensor data expected by the first device;
a transmitting period of the first information; or
a transmitting trigger event of the first information.

Optionally, the transmitting trigger event includes at least one of the following:
the second device enters a particular area;
a particular time is reached;
signal receiving information satisfies a first condition;
a moving distance of the second device is greater than a preset distance;
orientation change information of the second device satisfies a second condition;
a motion velocity of the second device satisfies a third condition;
environment change information measured by a sensor of the second device satisfies a fourth condition;
particular sensing that needs to be participated in by the second device or a communication service is initiated; or
a sensor measurement result corresponding to a first sensor in a usage state is associated with a target sensor measurement result, and the target sensor measurement result is associated with the sensor measurement result that is required, by the first device, to be fed back from the second device.

In an optional implementation, the operation of transmitting third indication information to the second device includes:
acquiring device information of the second device; and
transmitting the third indication information to the second device according to the device information.

The device information includes at least one of the following:
a type of a sensor supported by the second device;
a type of sensor data supported by the second device;
usage information of a sensor of the second device, where the accelerometer is in a use state due to requirements of other applications, and
optionally, the second device preferentially transmits an accelerometer measurement result, thereby reducing an additional cost of acquiring the sensor measurement data;
electric quantity information of the second device; or
a temperature the second device.

Specifically, the first device determines sensor capability information of the second device according to the device information of the second device. For example, if it is determined that a sensor type supported by the second device includes an accelerometer, the first device transmits the third indication information to instruct the second device to transmit the motion-related information.

In another optional implementation, the operation of transmitting third indication information to the second device includes:
acquiring, by the first device, signal receiving information of the second device; and
transmitting the third indication information to the second device in a case that the signal receiving information satisfies a first condition.

Optionally, the signal receiving information is signal receiving information of a first signal, i.e. signal receiving information obtained by measurement on the received first signal. The first signal may be a communication signal, a sensing signal, or a communication-sensing integrated signal. The first signal may be transmitted by the first device and received by the second device, or may be transmitted and received by the second device.

The signal receiving information includes at least one of the following:
received signal strength information, where the received signal strength information is obtained by the second device measuring a first signal, and the received signal strength information is, for example, reference signal received power (Reference Signal Receiving Power, RSRP), reference signal received quality (RSRQ), or a received signal strength indicator (RSSI);
signal to noise ratio or signal to interference plus noise ratio information, where the information may be specifically a communication signal to noise ratio (SNR)/interference signal to noise ratio (Signal to Interference plus Noise Ratio, SINR) (a ratio of received signal power to noise power or a ratio of received signal power to a sum of noise and interference power), or a sensing SNR/SINR (a ratio of signal component power associated with a sensing target in a received signal to noise power or a ratio of signal component power associated with a sensing target in a received signal to a sum of noise and interference power); or
receiving correctness-related information, for example, bit error rate information, and positive acknowledgement (ACK)/negative acknowledgement (ACK) information.

Optionally, the first operation includes at least one of the following:
determining a sensing result based on first information of at least one second device;
determining a start time and/or an end time of a sensing service;
triggering transmitting of a sensing signal;
performing beam management of the sensing service or a communication service; or
adjusting a communication rate.

Optionally, the method in this embodiment of this application further includes:
acquiring device information of the second device; and
determining, according to the device information, whether the second device is used as a sensing device.

The device information includes at least one of the following:
a type of a sensor supported by the second device;
a type of sensor data supported by the second device;
usage information of a sensor of the second device;
electric quantity information of the second device; or
a temperature the second device.

For example, a second device that is in a static state and has a measurement angle range covering an area where a target may exist is selected as the sensing device based on the motion velocity information and the orientation information.

Optionally, the type of the sensor in this embodiment of this application includes at least one of the following:
an acceleration sensor, a gyroscope, a magnetic force sensor, a rotation vector sensor, a location sensor, a pressure sensor, a temperature sensor, a humidity sensor, or an optical sensor.

Optionally, the method in this embodiment of this application further includes:
acquiring first request information transmitted by the second device, where the first request information is used for acquiring first information of a third device, and the third device is different from the second device; and
transmitting the first information of the third device to the second device according to the first request information.

Here, the second device determines a sensing result according to the first information of the third device and the first information of the second device. To be specific, a sensing result is determined with reference to sensor information of a plurality of devices.

In this embodiment of this application, a first device acquires first information of a second device, where the first information includes a sensor measurement result of the second device.

The sensor measurement result includes at least one of the following: a motion-related information measurement result; a position-related information measurement result; or an environment-related information measurement result. The first device executes a first operation according to the sensor measurement result. The first operation is related to at least one of a communication service and a sensing service, to achieve an objective of assisting in the communication service and/or the sensing service through sensor data. The impact of a motion of the device, a position of the device, an environment, or the like on a communication or sensing performance can be reduced through the sensor data, thereby facilitating improving the communication or sensing performance.

As shown in FIG. 3, an embodiment of this application further provides an information processing method, including the following steps.

Step 301: A second device transmits first information to a first device, where the first information includes a sensor measurement result of the second device, and the sensor measurement result is related to at least one of a communication service and a sensing service.

The sensor measurement result includes at least one of the following:
a motion-related information measurement result;
a position-related information measurement result; or
an environment-related information measurement result.

Optionally, the second device is a terminal.

Optionally, the second device is configured with at least one of the following sensors:
Accelerometer: An acceleration applied to the device is measured in a format of a=[aₓ, a_{y}, a_{z}]^{T}, including accelerations along an x-axis, a y-axis, and a z-axis. Further, there may further be a result including a gravitational acceleration, a result not including a gravitational acceleration, a result including deviation compensation, and a result not including deviation compensation.
Gyroscope: Rotation rates (radian/second) around the x, y, and z-axes of the device are measured, and may be represented as a three-dimensional vector similar to the accelerometer, ω=[ωₓ, ω_{y}, ω_{z}]^{T}.
Magnetometer: The change of the earth's magnetic field is monitored, and geomagnetic field strength data (in microtesla) along each of the three coordinate axes is measured, where the format is m=[mₓ, m_{y}, m_{z}]^{T} Generally, the sensor does not need to be directly used, but is combined with another sensor to acquire rotation angle information.
Rotation vector sensor: A rotation vector sensor may be obtained by combining different sensors, to acquire a terminal angle, where the format is θ=[θₓ, θ_{y}, θ_{z}]^{T} (respectively corresponding to rotation angles of the terminal about the x, y, and z-axes, or rotation angles relative to an East-North-Up/North-East-Down).
Global navigation satellite system (GNSS): The terminal receives a satellite signal broadcast by a navigation satellite, demodulates and collects sufficient data information, and then resolves position information of a current receiving end.
Pressure sensor: An environmental air pressure value is acquired.
Optical sensor: Many mobile terminals are provided with an optical sensor to sense illumination brightness of a current environment of a user, and adjust screen brightness based on the illumination brightness.
Temperature sensor: An environmental temperature is acquired.
Humidity sensor: Relative humidity information of an environment may be acquired, or dew point and/or absolute humidity information may be acquired in combination with the temperature sensor.

In the apparatus in this embodiment of this application, a second device transmits first information to a first device, where the first information includes a sensor measurement result of the second device, so that the first device assists in a communication service and/or a sensing service through sensor data, and the impact of a motion of the device, a position of the device, an environment, or the like on a communication or sensing performance can be reduced through the sensor data, thereby facilitating improving the communication or sensing performance.

Optionally, the motion-related information measurement result includes at least one of the following:
acceleration information of the second device;
velocity information of the second device;
rotation rate information of the second device; or
rotation angle information of the second device.

Optionally, the position-related information measurement result includes at least one of the following:
geomagnetic strength information;
moving distance information of the second device;
orientation information of the second device;
position information of the second device; or
distance information between the second device and a target object.

Optionally, the environment-related information measurement result includes at least one of the following:
an air temperature;
an illumination strength;
an air pressure; or
an air humidity.

Optionally, the first information further includes at least one of the following:
first indication information, where the first indication information is used for indicating a type of the sensor measurement result;
second indication information, where the second indication information is used for indicating a type of a sensor corresponding to the sensor measurement result;
first time information, where the first time information is used for indicating time information at which the second device obtains the sensor measurement result; or
coordinate system relationship information, where the coordinate system relationship information is used for indicating relationship information between a coordinate system corresponding to the sensor measurement result and a first coordinate system.

It should be noted that specific content of the first information has been described in detail in the method embodiment applied to the first device. Details are not described herein again.

Optionally, the operation that a second device transmits first information to a first device includes at least one of the following:
transmitting the first information to the first device according to third indication information transmitted by the second device, where the third indication information is used for instructing the second device to transmit the first information;
periodically transmitting the first information to the first device; or
transmitting the first information to the first device based on a preset event.

Optionally, the preset event includes at least one of the following:
the second device enters a particular area (for example, a cell);
a particular time is reached;
signal receiving information satisfies a first condition, where a parameter value of a
first signal is, for example, greater than a threshold;
a moving distance of the second device is greater than a preset distance;
orientation change information of the second device satisfies a second condition;
a motion velocity of the second device satisfies a third condition;
environment change information measured by a sensor of the second device satisfies a fourth condition, where a change value of the humidity, temperature, or illumination strength is, for example, greater than or less than a preset threshold;
particular sensing that needs to be participated in by the second device or a communication service is initiated; or
a sensor measurement result corresponding to a first sensor in a usage state is associated with a target sensor measurement result, and the target sensor measurement result is associated with the sensor measurement result that is required, by the first device, to be fed back from the second device, where to be specific, the sensor measurement result corresponding to the first sensor is associated with an ongoing communication or sensing service between the first device and the second device.

Optionally, the method in this embodiment of this application further includes:

transmitting signal receiving information to the first device, where the third indication information is transmitted in a case that the signal receiving information satisfies a first condition.

Optionally, the signal receiving information includes at least one of the following:
received signal strength information;
signal to noise ratio or signal to interference plus noise ratio information; or
receiving correctness-related information.

The signal receiving information has been described in detail in the method embodiment applied to the first device. Details are not described herein again.

Optionally, the method in this embodiment of this application further includes:
transmitting device information of the second device to the first device.

The device information includes at least one of the following:
a type of a sensor supported by the second device;
a type of sensor data supported by the second device;
usage information of a sensor of the second device;
electric quantity information of the second device; or
a temperature the second device.

Optionally, the type of the sensor includes at least one of the following:
an acceleration sensor, a gyroscope, a magnetic force sensor, a rotation vector sensor,
a location sensor, a pressure sensor, a temperature sensor, a humidity sensor, or an optical sensor.

Optionally, the method in this embodiment of this application further includes:
transmitting first request information to the first device, where the first request information is used for acquiring first information of a third device, and the third device is different from the second device; and
determining a sensing result according to the first information of the third device and the first information of the second device.

Here, the second device determines a sensing result according to the first information of the third device and the first information of the second device. To be specific, a sensing result is determined with reference to sensor information of a plurality of devices.

The information processing method in this application is described below with reference to specific embodiments.

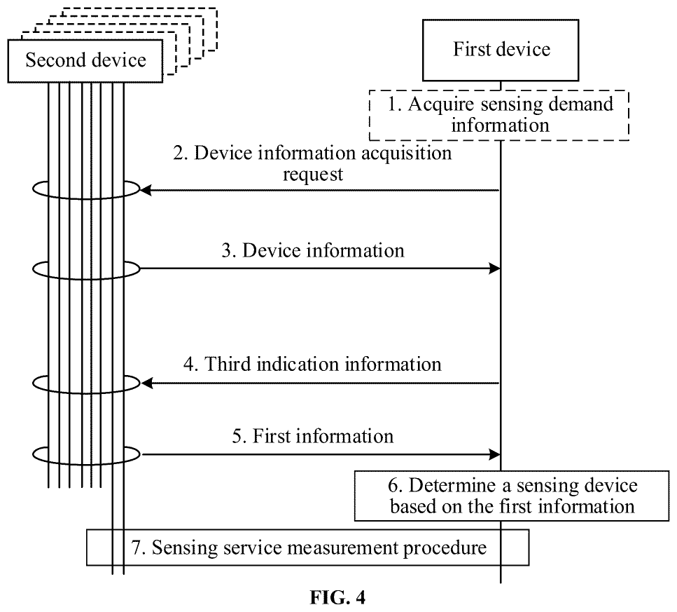

In a first embodiment of this application, selection of a sensing device is assisted by using the first information. Specifically, as shown in FIG. 4, the method includes the following steps.

Step 1: A first device acquires sensing demand information.

The first device may be specifically a base station or a communication medium frequency (Sensing Medium Frequency, Sensing MF).

The sensing demand information includes at least one of the following:
a sensing service, which is divided according to types or specifically divided into a service, for example, environmental reconstruction, breathing or heartbeat detection, location or tracking, action recognition, weather monitoring, radar ranging and velocity measurement, or the like;
a sensing target area, referring to a position area in which a sensing object may exist, or a position area in which imaging or environmental reconstruction needs to be performed;
a sensing object type, where sensing objects are classified according to possible motion characteristics, and each sensing object type contains information such as a motion velocity, a motion acceleration, and a typical radar cross section (RCS) of typical sensing objects;
a sensing QoS, referring to a performance index for sensing the sensing target area or the sensing object, including at least one of the following:
a sensing resolution (which may be further divided into a ranging resolution, an angle measurement resolution, a velocity measurement resolution, and an imaging resolution);
sensing accuracy (which may be further divided into ranging accuracy, angle measurement accuracy, velocity measurement accuracy, and location accuracy);
a sensing range (which may be further divided into a ranging range, a velocity measurement range, an angle measurement range, and an imaging range);
a sensing delay (a time interval from transmitting a sensing signal to obtaining a sensing result, alternatively, a time interval from initiating a sensing demand to obtaining a sensing result);
a sensing updating rate (a time interval between two adjacent executions of sensing and obtaining the sensing results);
a detection probability (a probability of being correctly detected in the presence of a sensing object);
a false alarm probability (a probability that a sensing target is incorrectly detected in the absence of a sensing object); or
a maximum number of sensible targets.

In this embodiment, it is assumed that the sensing service is locating a passive target in an environment, a distance and angle information of the target need to be acquired, and an area in which the target may exist is known. The passive target refers to a target that does not transmit or receive a signal.

Step 2: The first device transmits a device information acquisition request to a second device, to request for device information of the second device.

Step 3: The second device feeds back the device information to the first device according to the received device information acquisition request.

It is assumed that the device information is a sensor data type supported by the feedback, and a bitmap manner may be used. For example, x bits are used for corresponding to x sensor data types, where the supported sensor data type is represented as 1, and the unsupported sensor data type is represented as 0.

Step 4: The first device transmits third indication information to the second device, and acquires motion information and/or position information of the first device. Specifically, the information may be a motion velocity and orientation information of the first device.

Step 5: The second device feeds back first information to the first device based on the third indication information, where the first information includes a motion velocity and orientation information of the second device.

Step 6: The first device determines, based on the first information and/or the sensing demand information, whether the current second device is used as a sensing device. A specific manner may be, for example, selecting a second device that is in a static state and has a measurement angle range covering an area where a target may exist as the sensing device based on the motion velocity information and the orientation information.

Step 7: The first device determines at least one second device, to further determine a sensing device set, and performs a sensing service measurement procedure with the second device in the set: locating a passive target in an environment.

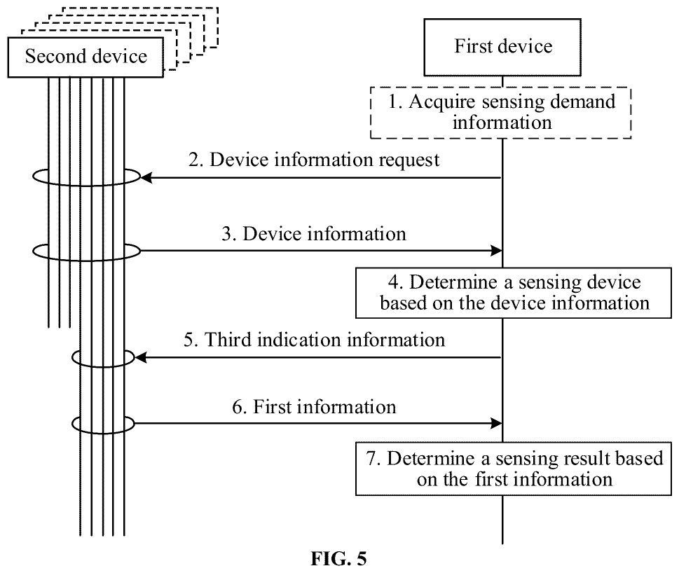

In a second embodiment of this application, the sensing result is determined through the first information. Specifically, as shown in FIG. 5, the method includes the following steps.

Step 1: A first device acquires sensing demand information. A sensing service in this embodiment is sensing environmental temperature/humidity information in a particular area.

The first device may be specifically a base station or a Sensing MF.

Step 2: The first device transmits a device information acquisition request to a second device, to request for device information of the second device.

Step 3: The second device feeds back the device information to the first device according to the received device information acquisition request.

Step 4: The first device selects, based on the device information, a second device supporting a temperature/humidity sensor as a sensing device.

Step 5: The first device transmits third indication information to the second device used as the sensing device, to instruct the second device to transmit temperature/humidity information and second device position information.

Step 6: The second device feeds back first information to the first device based on the third indication information, where the first information includes the temperature/humidity information and the second device position information.

Step 7: The first device obtains environmental temperature/humidity information in a particular area based on the temperature/humidity information and the position information that are fed back by at least one second device.

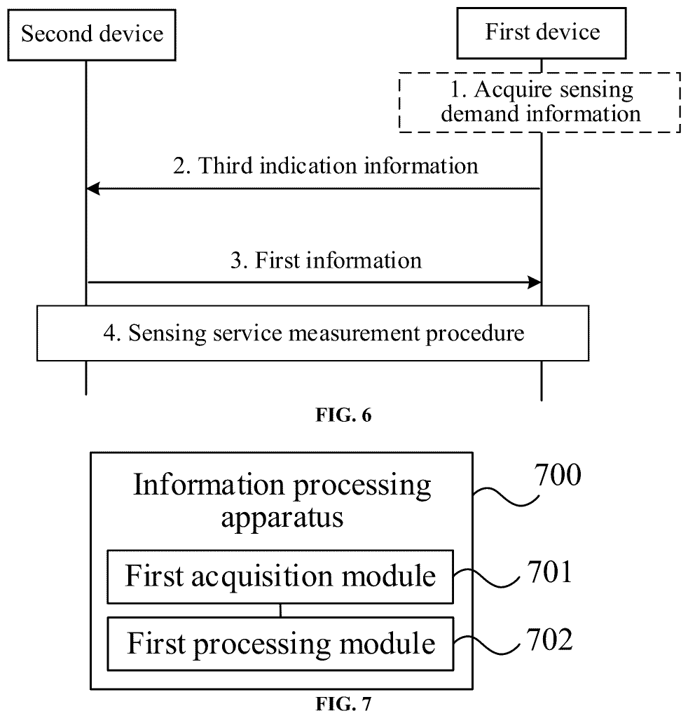

In a third embodiment of this application, the sensing service is triggered to be initiated or stopped, or the sensing signal is triggered to be transmitted by using the first information. Specifically, as shown in FIG. 6, the method includes the following steps.

Step 1: A first device acquires sensing demand information, where a sensing service in this embodiment is sleep breathing monitoring.

The first device may be specifically a base station or a Sensing MF.

Step 2: The first device transmits third indication information to a second device, indicating to the second device that:
a) Expected sensor measurement data is a motion velocity of the second device, a position of the second device, and/or an environment illumination strength.
b) An event triggering transmitting of first information includes at least one of the following:
a particular time is entered, for example, daily sleeping time;
a particular area is entered, for example, a bedroom;
the motion velocity of the second device is less than a threshold; or
the environment illumination strength is lower than a threshold.

Step 3: The second device invokes, based on the third indication information, a related sensor to acquire the expected sensor measurement data.

The second device transmits first information to the first device after the event triggering transmitting occurs, where the first information includes time information, and/or the motion velocity of the second device, and/or the position of the second device, and/or the environment illumination strength, and/or a sensing service measurement starting identifier.

Step 4: The first device determines, based on the received first information, that a sleep breathing monitoring sensing service measurement procedure is started, transmits a sensing signal, or instructs the second device to transmit the sensing signal, and performs a sensing measurement procedure.

For another example, the method in this embodiment specifically includes the following steps.

Step 1: A first device acquires sensing demand information, where a sensing service is gesture recognition.

The first device may be specifically a base station or a Sensing MF.

Step 2: The first device transmits third indication information to a second device, indicating to the first device that:
a) Expected sensor measurement data is a distance between the second device and an object, and/or a motion velocity of the second device.
b) An event triggering transmitting of the first information is that the distance between the second device and the object is less than a threshold, and/or the motion velocity of the second device is less than a threshold.

Step 3: The second device invokes, based on the third indication information, a related sensor to acquire the expected sensor measurement data.

The second device transmits first information to the first device after the event triggering transmitting occurs, where the first information includes the distance between the second device and the object, and/or the motion velocity of the second device, and/or a sensing service measurement starting identifier.

Step 4: The first device determines, based on the received first information, that a gesture recognition sensing service measurement procedure is started, transmits a sensing signal, or instructs the second device to transmit the sensing signal, and performs a sensing measurement procedure.

In a fourth embodiment of this application, the first information is triggered to be transmitted by wireless signal measurement. Specifically, the method includes the following steps.

Step 1: A first device (base station) transmits a first signal to a second device (terminal) for downlink channel measurement.

Step 2: The second device receives the first signal, performs measurement, and determines signal receiving information. For example, the signal receiving information is an SNR, and the second device feeds back the SNR to the first device.

Step 3: The first device receives the SNR, and when the SNR is lower than a preset threshold, the first device transmits third indication information to the second device, indicating to the second device that:
a) Sensor measurement data is transmitted.
b) Expected sensor measurement data is a position of the second device, and/or a motion velocity of the second device.

Step 4: The second device transmits, based on the third indication information, first information, i.e. the position of the second device and/or the motion velocity of the second device.

Step 5: The first device performs position prediction or transmission loss prediction on the second device based on the first information, and instructs the second device to perform beam switching or adjust a communication rate.

Alternatively, the method in this embodiment includes the following steps.

Step 1: A first device (base station) transmits third indication information to a second device (terminal), to indicate that a trigger event of transmitting first information is:
a) an SNR obtained by measurement of a first signal is lower than a preset threshold; and
b) expected sensor measurement data is a position of the second device, and/or a motion velocity of the second device.

Step 2: The first device transmits the first signal to the second device.

Step 3: The second device receives the first signal and performs measurement, and when the SNR is lower than the preset threshold, the second device transmits first information, i.e. the position of the second device and/or the motion velocity of the second device.

Step 4: The first device performs position prediction or transmission loss prediction on the second device based on the first information, and instructs the second device to perform beam switching or adjust a communication rate.

In this embodiment of this application, a first device acquires first information of a second device, where the first information includes a sensor measurement result of the second device.

The sensor measurement result includes at least one of the following: a motion-related information measurement result; a position-related information measurement result; or an environment-related information measurement result. The first device executes a first operation according to the sensor measurement result. The first operation is related to at least one of a communication service and a sensing service, to achieve an objective of assisting in the communication service and/or the sensing service through sensor data. The impact of a motion of the device, a position of the device, an environment, or the like on a communication or sensing performance can be reduced through the sensor data, thereby facilitating improving the communication or sensing performance.

An executive body of the information processing method provided by the embodiments of this application may be an information processing apparatus. In this embodiment of this application, the information processing apparatus executing the information processing method is used as an example to explain the information processing apparatus provided by the embodiments of this application.

As shown in FIG. 7, an embodiment of this application further provides an information processing apparatus 700, applied to a first device. The apparatus includes:

a first acquisition module 701, configured to acquire first information of a second device, where the first information includes a sensor measurement result of the second device; and

a first processing module 702, configured to execute a first operation according to the sensor measurement result, where the first operation is related to at least one of a communication service and a sensing service.

The sensor measurement result includes at least one of the following:
a motion-related information measurement result;
a position-related information measurement result; or
an environment-related information measurement result.

Optionally, the motion-related information measurement result includes at least one of the following:
acceleration information of the second device;
velocity information of the second device;
rotation rate information of the second device; or
rotation angle information of the second device.

Optionally, the position-related information measurement result includes at least one of the following:
geomagnetic strength information;
moving distance information of the second device;
orientation information of the second device;
position information of the second device; or
distance information between the second device and a target object.

Optionally, the environment-related information measurement result includes at least one of the following:
an air temperature;
an illumination strength;
an air pressure; or
an air humidity.

Optionally, the first information further includes at least one of the following:
first indication information, where the first indication information is used for indicating a type of the sensor measurement result;
second indication information, where the second indication information is used for indicating a type of a sensor corresponding to the sensor measurement result;
first time information, where the first time information is used for indicating time information at which the second device obtains the sensor measurement result; or
coordinate system relationship information, where the coordinate system relationship information is used for indicating relationship information between a coordinate system corresponding to the sensor measurement result and a first coordinate system.

Optionally, the apparatus in this embodiment of this application further includes:
a first transmission module, configured to transmit, before the first acquisition module acquires the first information, third indication information to the second device, where the third indication information is used for instructing the second device to transmit the first information.

Optionally, the third indication information includes at least one of the following:
transmitting indication information, where the transmitting indication information is used for indicating whether the second device transmits the sensor measurement result;
a type of a sensor expected to be used by the first device;
a type of sensor data expected by the first device;
a transmitting period of the first information; or
a transmitting trigger event of the first information.

Optionally, the first transmission module includes:
a first acquisition submodule, configured to acquire device information of the second device; and
a first transmitting submodule, configured to transmit the third indication information to the second device according to the device information.

The device information includes at least one of the following:
a type of a sensor supported by the second device;
a type of sensor data supported by the second device;
usage information of a sensor of the second device;
electric quantity information of the second device; or
a temperature the second device.

Optionally, the first transmission module includes:
a second acquisition submodule, configured to acquire signal receiving information of
the second device; and
a second transmitting submodule, configured to transmit the third indication information to the second device in a case that the signal receiving information satisfies a first condition.

The signal receiving information includes at least one of the following:
received signal strength information;
signal to noise ratio or signal to interference plus noise ratio information; or
receiving correctness-related information.

Optionally, the first operation includes at least one of the following:
determining a sensing result based on first information of at least one second device;
determining a start time and/or an end time of a sensing service;
triggering transmitting of a sensing signal;
performing beam management of the sensing service or a communication service; or
adjusting a communication rate.

Optionally, the apparatus in this embodiment of this application further includes:
a second acquisition module, configured to acquire device information of the second device; and
a first determination module, configured to determine, according to the device information, whether the second device is used as a sensing device.

The device information includes at least one of the following:
a type of a sensor supported by the second device;
a type of sensor data supported by the second device;
usage information of a sensor of the second device;
electric quantity information of the second device; or
a temperature the second device.

Optionally, the type of the sensor includes at least one of the following:
an acceleration sensor, a gyroscope, a magnetic force sensor, a rotation vector sensor, a location sensor, a pressure sensor, a temperature sensor, a humidity sensor, or an optical sensor.

Optionally, the apparatus in this embodiment of this application further includes:
a third acquisition module, configured to acquire first request information transmitted by the second device, where the first request information is used for acquiring first information of a third device, and the third device is different from the second device; and
a second transmitting module, configured to transmit the first information of the third device to the second device according to the first request information.

Optionally, the first device is a base station, a sensing network function, or a sensing network element.

In this embodiment of this application, a first device acquires first information of a second device, where the first information includes a sensor measurement result of the second device.

The sensor measurement result includes at least one of the following: a motion-related information measurement result; a position-related information measurement result; or an environment-related information measurement result. The first device executes a first operation according to the sensor measurement result. The first operation is related to at least one of a communication service and a sensing service, to achieve an objective of assisting in the communication service and/or the sensing service through sensor data. The impact of a motion of the device, a position of the device, an environment, or the like on a communication or sensing performance can be reduced through the sensor data, thereby facilitating improving the communication or sensing performance.

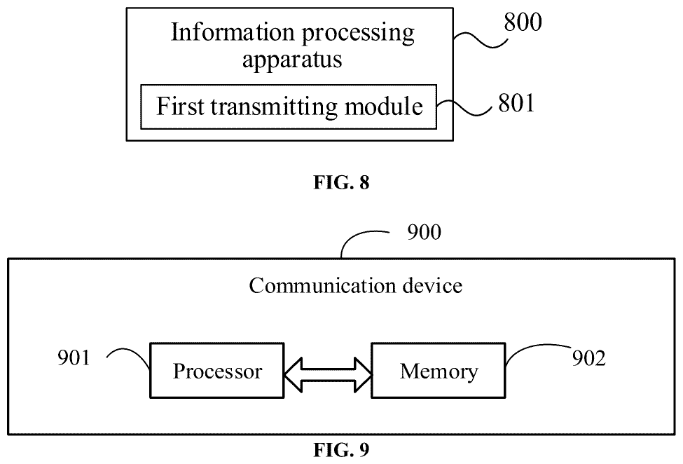

As shown in FIG. 8, an embodiment of this application further provides an information processing apparatus 800, applied to a second device. The apparatus includes:
a first transmitting module 801, configured to transmit, by the second device, first information to a first device, where the first information includes a sensor measurement result of the second device, and the sensor measurement result is related to at least one of a communication service and a sensing service.

The sensor measurement result includes at least one of the following:
a motion-related information measurement result;
a position-related information measurement result; or
an environment-related information measurement result.

Optionally, the motion-related information measurement result includes at least one of the following:
acceleration information of the second device;
velocity information of the second device;
rotation rate information of the second device; or
rotation angle information of the second device.

Optionally, the position-related information measurement result includes at least one of the following:
geomagnetic strength information;
moving distance information of the second device;
orientation information of the second device;
position information of the second device; or
distance information between the second device and a target object.

Optionally, the environment-related information measurement result includes at least one of the following:
an air temperature;
an illumination strength;
an air pressure; or
an air humidity.

Optionally, the first information further includes at least one of the following:
first indication information, where the first indication information is used for indicating
a type of the sensor measurement result;
second indication information, where the second indication information is used for indicating a type of a sensor corresponding to the sensor measurement result;
first time information, where the first time information is used for indicating time information at which the second device obtains the sensor measurement result; or
coordinate system relationship information, where the coordinate system relationship information is used for indicating relationship information between a coordinate system corresponding to the sensor measurement result and a first coordinate system.

Optionally, the first transmitting module is configured to perform at least one of the following:
transmitting the first information to the first device according to third indication information transmitted by the second device, where the third indication information is used for instructing the second device to transmit the first information;
periodically transmitting the first information to the first device; or
transmitting the first information to the first device based on a preset event.

Optionally, the preset event includes at least one of the following:
the second device enters a particular area;
a particular time is reached;
signal receiving information satisfies a first condition;
a moving distance of the second device is greater than a preset distance;
orientation change information of the second device satisfies a second condition;
a motion velocity of the second device satisfies a third condition;
environment change information measured by a sensor of the second device satisfies a fourth condition;
particular sensing that needs to be participated in by the second device or a communication service is initiated; or
a sensor measurement result corresponding to a first sensor in a usage state is associated with a target sensor measurement result, and the target sensor measurement result is associated with the sensor measurement result that is required, by the first device, to be fed back from the second device.

Optionally, the apparatus in this embodiment of this application further includes:
a first reporting module, configured to transmit first signal receiving information to the first device, where the third indication information is transmitted in a case that the signal receiving information satisfies a first condition.

Optionally, the signal receiving information includes at least one of the following:
received signal strength information, where the received signal strength information is obtained by the second device measuring a first signal;
signal to noise ratio or signal to interference plus noise ratio information; or
receiving correctness-related information.

Optionally, the apparatus in this embodiment of this application further includes:
a third transmitting module, configured to transmit device information of the second device to the first device.

The device information includes at least one of the following:
a type of a sensor supported by the second device;
a type of sensor data supported by the second device;
usage information of a sensor of the second device;
electric quantity information of the second device; or
a temperature the second device.

Optionally, the type of the sensor includes at least one of the following:
an acceleration sensor, a gyroscope, a magnetic force sensor, a rotation vector sensor,
a location sensor, a pressure sensor, a temperature sensor, a humidity sensor, or an optical sensor.

Optionally, the apparatus in this embodiment of this application further includes:
a fourth transmitting module, configured to transmit first request information to the first device, where the first request information is used for acquiring first information of a third device, and the third device is different from the second device; and
a second determination module, configured to determine a sensing result according to the first information of the third device and the first information of the second device.

Optionally, the second device is a terminal.

The apparatus in this embodiment of this application transmits first information to a first device, where the first information includes a sensor measurement result of a second device, so that the first device assists in a communication service and/or a sensing service through sensor data, and the impact of a motion of the device, a position of the device, an environment, or the like on a communication or sensing performance can be reduced through the sensor data, thereby facilitating improving the communication or sensing performance.

The information processing apparatus in this embodiment of this application may be an electronic device, for example, an electronic device with an operating system, or may be a component in an electronic device, for example, an integrated circuit or chip. The electronic device may be a terminal, or may be another device other than a terminal. For example, the terminal may include, but is not limited to, types of the terminal 11 listed above. The another device may be a server, a network attached storage (NAS), or the like. This is not specifically limited in this embodiment of this application.

The information processing apparatus provided in this embodiment of this application can implement processes implemented in the method embodiments of FIG. 2 to FIG. 6, and the same technical effect is achieved. To avoid repetition, details are not described herein.

Optionally, as shown in FIG. 9, an embodiment of this application further provides a communication device 900, including a processor 901 and a memory 902. The memory 902 has a program or an instruction executable on the processor 901 therein. For example, when the communication device 900 is a terminal, when the program or the instruction is executed by the processor 901, the steps in the method embodiment applied to the second device are implemented, and the same technical effect can be achieved. When the communication device 900 is a network-side device, the program or the instruction, when executed by the processor 901, implements the steps of the method embodiment applied to the first device, and the same technical effect can be achieved. To avoid repetition, details are not described herein.

An embodiment of this application further provides a terminal, including a processor and a communication interface. The communication interface is configured to transmit first information to a first device, where the first information includes a sensor measurement result of the second device, and the sensor measurement result is related to at least one of a communication service and a sensing service.

The sensor measurement result includes at least one of the following:
a motion-related information measurement result;
a position-related information measurement result; or
an environment-related information measurement result.

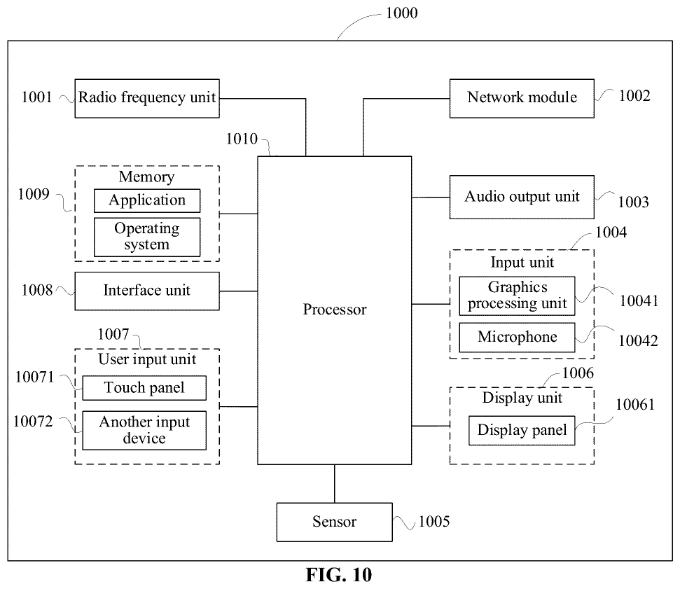

The terminal embodiment corresponds to the foregoing method embodiment applied to the second device. Implementation processes and implementations of the foregoing method embodiment all may be applied to the terminal embodiment, and the same technical effect can be achieved. Specifically, FIG. 10 is a schematic diagram of a hardware structure of a terminal for implementing an embodiment of this application.

The terminal 1000 includes but is not limited to: at least some components in a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art may understand that the terminal 1000 may further include a power supply (such as a battery) that supplies power to the components. The power supply may be logically connected to the processor 1010 through a power management system, thereby implementing functions such as management of charging, discharging, and power consumption through the power management system. The terminal structure shown in FIG. 10 constitutes no limitation on the terminal. The terminal may include more or fewer components than those shown in the figure, or some merged components, or different component arrangements. Details are not described herein.

It will be understood that in this embodiment of this application, the input unit 1004 may include a graphics processing unit (GPU) 10041 and a microphone 10042. The graphics processing unit 10041 processes image data of a static picture or a video obtained by an image capture apparatus (for example, a camera) in a video capture mode or an image capture mode. The display unit 1006 may include a display panel 10061. The display panel 10061 may be configured by using a liquid crystal display, an organic light-emitting diode, or the like. The user input unit 1007 includes at least one of a touch panel 10071 or another input device 10072. The touch panel 10071 is also referred to as a touch screen. The touch panel 10071 may include two parts: a touch detection apparatus and a touch controller. The another input device 10072 may include, but is not limited to, a physical keyboard, a functional key (such as a volume control key or a switch key), a track ball, a mouse, and a joystick. Details are not described herein again.

In this embodiment of this application, the radio frequency unit 1001 receives downlink data from a network-side device, and then may transmit the downlink data to the processor 1010 for processing. In addition, the radio frequency unit 1001 may transmit uplink data to the network-side device. Generally, the radio frequency unit 1001 includes, but is not limited to, an antenna, an amplifier, a transceiver, a coupler, a low noise amplifier, a duplexer, and the like.

The memory 1009 may be configured to store a software program or instruction and various data. The memory 1009 may include mainly a first storage area for storing a program or an instruction and a second storage area for storing data. The first storage area may store an operating system, an application or an instruction required for at least one function (such as a sound playback function and an image playback function), and the like. Furthermore, the memory 1009 may include a volatile memory or a non-volatile memory, or the memory 1009 may include both a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch link DRAM, SLDRAM), and a direct Rambus random access memory (Direct Rambus RAM, DRRAM). The memory 1009 in this embodiment of this application includes, but is not limited to, these memories and any other suitable types of memories.

The processor 1010 may include one or more processing units. Optionally, the processor 1010 integrates an application processor and a modem processor, where the application processor mainly processes operations relating to an operating system, a user interface, an application, and the like, and the modem processor, such as a baseband processor, mainly processes a wireless communication signal. It may be understood that the foregoing modem may not be integrated into the processor 1010.

The radio frequency unit 1001 is configured to transmit first information to a first device, where the first information includes a sensor measurement result of the second device, and the sensor measurement result is related to at least one of a communication service and a sensing service.

The sensor measurement result includes at least one of the following:
a motion-related information measurement result;
a position-related information measurement result; or
an environment-related information measurement result.

Optionally, the motion-related information measurement result includes at least one of the following:
acceleration information of the second device;
velocity information of the second device;
rotation rate information of the second device; or
rotation angle information of the second device.

Optionally, the position-related information measurement result includes at least one of the following:
geomagnetic strength information;
moving distance information of the second device;
orientation information of the second device;
position information of the second device; or
distance information between the second device and a target object.

Optionally, the environment-related information measurement result includes at least one of the following:
an air temperature;
an illumination strength;
an air pressure; or
an air humidity.

Optionally, the first information further includes at least one of the following:
first indication information, where the first indication information is used for indicating
a type of the sensor measurement result;
second indication information, where the second indication information is used for indicating a type of a sensor corresponding to the sensor measurement result;
first time information, where the first time information is used for indicating time information at which the second device obtains the sensor measurement result; or
coordinate system relationship information, where the coordinate system relationship information is used for indicating relationship information between a coordinate system corresponding to the sensor measurement result and a first coordinate system.

Optionally, the radio frequency unit 1001 is configured to perform at least one of the following:
transmitting the first information to the first device according to third indication information transmitted by the second device, where the third indication information is used for instructing the second device to transmit the first information;
periodically transmitting the first information to the first device; or
transmitting the first information to the first device based on a preset event.

Optionally, the preset event includes at least one of the following:
the second device enters a particular area;
a particular time is reached;
signal receiving information satisfies a first condition;
a moving distance of the second device is greater than a preset distance;
orientation change information of the second device satisfies a second condition;
a motion velocity of the second device satisfies a third condition;
environment change information measured by a sensor of the second device satisfies a fourth condition;
particular sensing that needs to be participated in by the second device or a communication service is initiated; or
a sensor measurement result corresponding to a first sensor in a usage state is associated
with a target sensor measurement result, and the target sensor measurement result is associated with the sensor measurement result that is required, by the first device, to be fed back from the second device.

Optionally, the radio frequency unit 1001 is configured to transmit signal receiving information to the first device, where the third indication information is transmitted in a case that the signal receiving information satisfies a first condition.

Optionally, the signal receiving information includes at least one of the following:
received signal strength information;
signal to noise ratio or signal to interference plus noise ratio information; or
receiving correctness-related information.

Optionally, the radio frequency unit 1001 is configured to transmit device information of the second device to the first device.

The device information includes at least one of the following:
a type of a sensor supported by the second device;
a type of sensor data supported by the second device;
usage information of a sensor of the second device;
electric quantity information of the second device; or
a temperature the second device.

Optionally, the type of the sensor includes at least one of the following:
an acceleration sensor, a gyroscope, a magnetic force sensor, a rotation vector sensor, a location sensor, a pressure sensor, a temperature sensor, a humidity sensor, or an optical sensor.

Optionally, the radio frequency unit 1001 is configured to transmit first request information to the first device, where the first request information is used for acquiring first information of a third device, and the third device is different from the second device.

The processor 1010 is configured to determine a sensing result according to the first information of the third device and the first information of the second device.

Optionally, the second device is a terminal.

In the apparatus in this embodiment of this application, a second device transmits first information to a first device, where the first information includes a sensor measurement result of the second device, so that the first device assists in a communication service and/or a sensing service through sensor data, and the impact of a motion of the device, a position of the device, an environment, or the like on a communication or sensing performance can be reduced through the sensor data, thereby facilitating improving the communication or sensing performance.

An embodiment of this application further provides a network-side device (the foregoing first device), including a processor and a communication interface. The communication interface is configured to acquire first information of a second device, where the first information includes a sensor measurement result of the second device. The processor is configured to execute a first operation according to the sensor measurement result, where the first operation is related to at least one of a communication service and a sensing service.

The sensor measurement result includes at least one of the following:
a motion-related information measurement result;
a position-related information measurement result; or
an environment-related information measurement result.

The network-side device embodiment corresponds to the foregoing method embodiment applied to the first device. Implementation processes and implementations of the foregoing method embodiment all may be applied to the network-side device embodiment, and the same technical effect can be achieved.

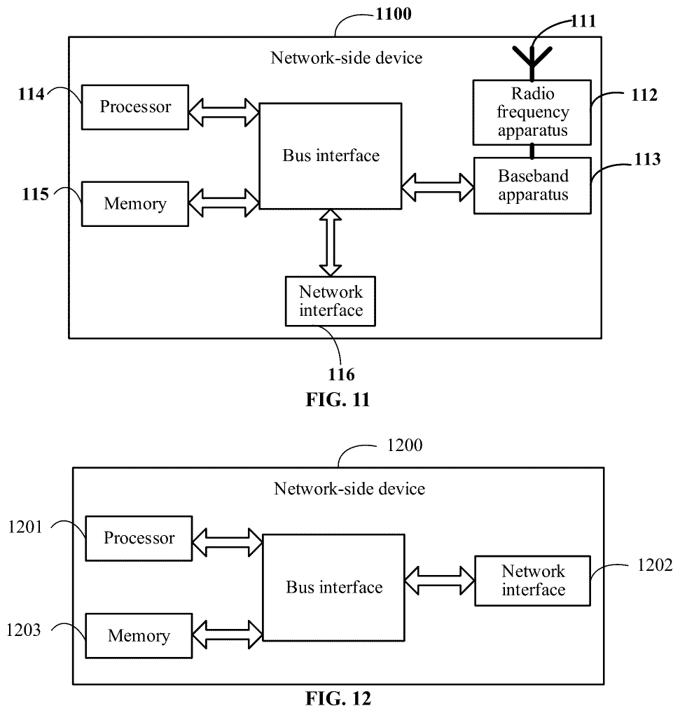

Specifically, an embodiment of this application further provides a network-side device (first device). As shown in FIG. 11, the network-side device 1100 includes: an antenna 111, a radio frequency apparatus 112, a baseband apparatus 113, a processor 114, and a memory 115. The antenna 111 is connected to the radio frequency apparatus 112. In an uplink direction, the radio frequency apparatus 112 receives information through the antenna 111, and transmits the received information to the baseband apparatus 113 for processing. In a downlink direction, the baseband apparatus 113 processes information to be transmitted, and transmits the information to the radio frequency apparatus 112. The radio frequency apparatus 112 processes the received information, and transmits the information via the antenna 111.

The method performed by the first device in the foregoing embodiment may be implemented in the baseband apparatus 113. The baseband apparatus 113 includes a baseband processor.

The baseband apparatus 113 may include, for example, at least one baseband board. A plurality of chips are disposed on the baseband board. As shown in FIG. 11, one of the chips is, for example, the baseband processor, which is connected to the memory 115 through a bus interface to invoke a program in the memory 115 to execute the network device operations shown in the foregoing method embodiment.

The network-side device may further include a network interface 116. The interface is, for example, a common public radio interface (CPRI).

Specifically, the network-side device 1100 in this embodiment of this application further includes: an instruction or a program stored in the memory 115 and executable on the processor 114. The processor 114 invokes the instruction or the program in the memory 115 to perform the method performed by each module shown in FIG. 7, and the same technical effect is achieved. To avoid repetition, details are not described herein again.

Specifically, an embodiment of this application further provides a network-side device. As shown in FIG. 12, the network-side device 1200 includes: a processor 1201, a network interface 1202, and a memory 1203. The network interface 1202 is, for example, a common public radio interface (CPRI).

Specifically, the network-side device 1200 in this embodiment of this application further includes: an instruction or a program stored in the memory 1203 and executable on the processor 1201. The processor 1201 invokes the instruction or the program in the memory 1203 to perform the method performed by each module shown in FIG. 7, and the same technical effect is achieved. To avoid repetition, details are not described herein again.

An embodiment of this application further provides a readable storage medium. The readable storage medium has a program or an instruction stored therein. The program or the instruction, when executed by a processor, implements the processes of the foregoing information processing method embodiment, and the same technical effect is achieved. To avoid repetition, details are not described herein again.

The processor is a processor of the terminal in the foregoing embodiment. The readable storage medium includes a computer-readable storage medium, such as a computer read-only memory ROM, a random access memory RAM, a magnetic disc, an optical disc, or the like.

An embodiment of this application further provides a chip. The chip includes a processor and a communication interface. The communication interface is coupled to the processor.

The processor is configured to execute a program or an instruction, to implement the processes of the foregoing information processing method embodiment, and the same technical effect is achieved. To avoid repetition, details are not described herein again.

It will be understood that the chip mentioned in this embodiment of this application may alternatively be referred to as a system on a chip, a system chip, a chip system, a system-on-chip, or the like.

An embodiment of this application further provides a computer program/program product. The computer program/program product is stored in a storage medium. The computer program/program product, when executed by at least one processor, implements the processes of the foregoing information processing method embodiment, and the same technical effect is achieved. To avoid repetition, details are not described herein again.

An embodiment of this application further provides an information processing system, including: a first device and a second device. The first device may be configured to perform the steps of the information processing method applied to the first device as described above. The second device may be configured to perform the steps of the information processing method applied to the second device as described above.

It should be noted that terms “include”, “comprise”, or any other variation thereof herein is intended to cover a non-exclusive inclusion, so that a process, method, article, or apparatus including a series of elements not only includes those elements but also includes other elements which are not clearly listed or further includes intrinsic elements of the process, method, article, or apparatus. Without more limitations, an element defined by a sentence “including one” does not exclude a case that there are still other same elements in the process, method, article, or apparatus that includes the element. Furthermore, it should be pointed out that the range of the method and apparatus in the implementations of this application is not limited to execution of functions in order shown or discussed, and may further include execution of functions involved in a substantially simultaneous manner or in reverse order. For example, the described method may be performed in order different from that described, and various steps may be added, omitted, or combined. In addition, features described with reference to some examples may be combined in other examples.

According to the descriptions in the foregoing implementations, a person skilled in the art may clearly learn that the method according to the foregoing embodiment may be implemented by relying on software and a commodity hardware platform, which is preferred in many cases, or by using hardware. Based on such an understanding, the technical solutions of this application essentially, or a part contributing to the prior art, may be presented in a form of a computer software product. The computer software product is stored in a storage medium (for example, a ROM/RAM, a magnetic disk, or an optical disc) including several instructions to enable a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations. The foregoing specific implementations are merely illustrative rather than restrictive. Inspired by this application, a person of ordinary skill in the art may still make multiple forms without departing from the essence of this application and the scope of protection of the claims, which all fall within the protection of this application.

What is claimed is:

1. An information processing method, comprising:
acquiring, by a first device, first information of a second device, wherein the first information comprises a sensor measurement result of the second device; and
executing, by the first device, a first operation according to the sensor measurement result, wherein the first operation is related to at least one of a communication service or a sensing service, and
the sensor measurement result comprises at least one of the following:
a motion-related information measurement result;
a position-related information measurement result; or
an environment-related information measurement result.

2. The method according to claim 1, wherein the motion-related information measurement result comprises at least one of the following:
acceleration information of the second device;
velocity information of the second device;
rotation rate information of the second device; or
rotation angle information of the second device.

3. The method according to claim 1, wherein the position-related information measurement result comprises at least one of the following:
geomagnetic strength information;
moving distance information of the second device;
orientation information of the second device;
position information of the second device; or
distance information between the second device and a target object.

4. The method according to claim 1, wherein the environment-related information measurement result comprises at least one of the following:
an air temperature;
an illumination strength;
an air pressure; or
an air humidity.

5. The method according to claim 1, wherein the first information further comprises at least one of the following:
first indication information, wherein the first indication information is used for indicating a type of the sensor measurement result;
second indication information, wherein the second indication information is used for indicating a type of a sensor corresponding to the sensor measurement result;
first time information, wherein the first time information is used for indicating time information at which the second device obtains the sensor measurement result; or
coordinate system relationship information, wherein the coordinate system relationship information is used for indicating relationship information between a coordinate system corresponding to the sensor measurement result and a first coordinate system.

6. The method according to claim 1, wherein before the acquiring, by a first device, first information, the method further comprises:
transmitting third indication information to the second device, wherein the third indication information is used for instructing the second device to transmit the first information.

7. The method according to claim 6, wherein the third indication information comprises at least one of the following:
transmitting indication information, wherein the transmitting indication information is used for indicating whether the second device transmits the sensor measurement result;
a type of a sensor expected to be used by the first device;
a type of sensor data expected by the first device;
a transmitting period of the first information; or
a transmitting trigger event of the first information.

8. The method according to claim 7, wherein the transmitting third indication information to the second device comprises:
acquiring device information of the second device; and
transmitting the third indication information to the second device according to the device information,
wherein the device information comprises at least one of the following:
a type of a sensor supported by the second device;
a type of sensor data supported by the second device;
usage information of a sensor of the second device;
electric quantity information of the second device; or
a temperature the second device.

9. The method according to claim 6, wherein the transmitting third indication information to the second device comprises:
acquiring, by the first device, signal receiving information of the second device; and
transmitting the third indication information to the second device in a case that the signal receiving information satisfies a first condition,
wherein the signal receiving information comprises at least one of the following:
received signal strength information;
signal to noise ratio or signal to interference plus noise ratio information; or
receiving correctness-related information.

10. The method according to claim 1, wherein the first operation comprises at least one of the following:
determining a sensing result based on first information of at least one second device;
determining a start time and/or an end time of a sensing service;
triggering transmitting of a sensing signal;
performing beam management of the sensing service or a communication service; or
adjusting a communication rate; or,
wherein the method further comprises:
acquiring device information of the second device; and
determining, according to the device information, whether the second device is used as a sensing device,
wherein the device information comprises at least one of the following:
a type of a sensor supported by the second device;
a type of sensor data supported by the second device;
usage information of a sensor of the second device;
electric quantity information of the second device; or
a temperature the second device.

11. The method according to claim 5, wherein the type of the sensor comprises at least one of the following:
an acceleration sensor, a gyroscope, a magnetic force sensor, a rotation vector sensor, a location sensor, a pressure sensor, a temperature sensor, a humidity sensor, or an optical sensor.

12. The method according to claim 1, further comprising:
acquiring first request information transmitted by the second device, wherein the first request information is used for acquiring first information of a third device, and the third device is different from the second device; and
transmitting the first information of the third device to the second device according to the first request information; or,
wherein the first device is a base station, a sensing network function, or a sensing network element.

13. An information processing method, comprising:
transmitting, by a second device, first information to a first device, wherein the first information comprises a sensor measurement result of the second device, the sensor measurement result is related to at least one of a communication service or a sensing service, and
the sensor measurement result comprises at least one of the following:
a motion-related information measurement result;
a position-related information measurement result; or
an environment-related information measurement result.

14. The method according to claim 13, wherein the motion-related information measurement result comprises at least one of the following:
acceleration information of the second device;
velocity information of the second device;
rotation rate information of the second device; or
rotation angle information of the second device; or,
wherein the position-related information measurement result comprises at least one of the following:
geomagnetic strength information;
moving distance information of the second device;
orientation information of the second device;
position information of the second device; or
distance information between the second device and a target object; or,
wherein the environment-related information measurement result comprises at least one of the following:
an air temperature;
an illumination strength;
an air pressure; or
an air humidity; or,
wherein the first information further comprises at least one of the following:
first indication information, wherein the first indication information is used for indicating a type of the sensor measurement result;
second indication information, wherein the second indication information is used for indicating a type of a sensor corresponding to the sensor measurement result;
first time information, wherein the first time information is used for indicating time information at which the second device obtains the sensor measurement result; or
coordinate system relationship information, wherein the coordinate system relationship information is used for indicating relationship information between a coordinate system corresponding to the sensor measurement result and a first coordinate system.

15. The method according to claim 13, wherein the transmitting, by a second device, first information to a first device comprises at least one of the following:
transmitting the first information to the first device according to third indication information transmitted by the second device, wherein the third indication information is used for instructing the second device to transmit the first information;
periodically transmitting the first information to the first device; or
transmitting the first information to the first device based on a preset event.

16. The method according to claim 15, wherein the preset event comprises at least one of the following:
the second device enters a particular area;
a particular time is reached;
signal receiving information satisfies a first condition;
a moving distance of the second device is greater than a preset distance;
orientation change information of the second device satisfies a second condition;
a motion velocity of the second device satisfies a third condition;
environment change information measured by a sensor of the second device satisfies a fourth condition;
particular sensing that needs to be participated in by the second device or a communication service is initiated; or
a sensor measurement result corresponding to a first sensor in a usage state is associated with a target sensor measurement result, and the target sensor measurement result is associated with the sensor measurement result that is required, by the first device, to be fed back from the second device; or,
wherein the method further comprises:
transmitting signal receiving information to the first device, wherein the third indication information is transmitted in a case that the signal receiving information satisfies a first condition.

17. The method according to claim 16, wherein the signal receiving information comprises at least one of the following:
received signal strength information;
signal to noise ratio or signal to interference plus noise ratio information; or
receiving correctness-related information.

18. The method according to claim 13, further comprising:
transmitting device information of the second device to the first device,
wherein the device information comprises at least one of the following:
a type of a sensor supported by the second device;
a type of sensor data supported by the second device;
usage information of a sensor of the second device;
electric quantity information of the second device; or
a temperature the second device; or,
wherein the method further comprises:
transmitting first request information to the first device, wherein the first request information is used for acquiring first information of a third device, and the third device is different from the second device; and
determining a sensing result according to the first information of the third device and the first information of the second device; or,
wherein the second device is a terminal.

19. A communication device, comprising a processor and a memory, wherein the memory stores a program or an instruction executable on the processor, wherein the program or the instruction, when executed by the processor, causes the communication device to perform:
acquiring first information of a second device, wherein the first information comprises a sensor measurement result of the second device; and
executing a first operation according to the sensor measurement result, wherein the first operation is related to at least one of a communication service or a sensing service, and
the sensor measurement result comprises at least one of the following:
a motion-related information measurement result;
a position-related information measurement result; or
an environment-related information measurement result.

20. A communication device, comprising a processor and a memory, wherein the memory stores a program or an instruction executable on the processor, and the program or the instruction, when executed by the processor, implements the steps of the information processing method according to claim 13.
